(19) United States
(12) Patent Application Publication
(10) Pub. No.: US 2026/0365872 A1
(43) Pub. Date: Nov. 19, 2026

(54) PRE-TREATMENT LIQUID AND INK SET

(71) Applicant: KYOCERA DOCUMENT SOLUTIONS INC., OSAKA (JP)

(72) Inventor: AZUMI ISHIDA, OSAKA (JP)

(21) Appl. No.: 19/667,668

(22) Filed: May 5, 2026

(30) Foreign Application Priority Data
May 12, 2025 (JP) 2025-080122

(51) Int. Cl. C09D 11/54; C09D 11/30; C09D 11/38

(52) U.S. Cl. CPC C09D 11/54; C09D 11/30; C09D 11/38

(57) ABSTRACT

A pre-treatment liquid is used for pre-treatment of a recording medium on which an image is recorded with a water-based ink that includes a pigment and a pigment dispersion resin. The pre-treatment liquid includes: 2 mass % or more and 8 mass % or less of a water-soluble cationic polymer, 5 mass % or more and 15 mass % or less of a first moisturizing agent, a first water-soluble organic solvent, a first surfactant, and water. The first moisturizing agent is trimethylolpropane.

### CROSS-REFERENCE TO RELATED PATENT APPLICATION

This application claims the benefit of Japanese Priority Patent Application JP 2025-080122 filed on May 12, 2025, the entire contents of which are incorporated herein by reference.

### FIELD OF THE DISCLOSURE

The present disclosure relates to a pre-treatment liquid and an ink set.

### BACKGROUND OF THE DISCLOSURE

There is known a technology for performing pre-treatment on a recording medium with a pre-treatment liquid before forming an image with a water-based ink in order to form a high-quality image with high density while suppressing image defects such as color unevenness and image cracking. As the pre-treatment liquid, one that allows an image with sufficiently high density to be formed with a small amount of water-based ink by the action of a metal salt that makes pigments more likely to agglomerate on the surface of the recording medium has been known.

### SUMMARY OF THE DISCLOSURE

A pre-treatment liquid according to an embodiment of the present disclosure is used for pre-treatment of a recording medium on which an image is recorded with a water-based ink that includes a pigment and a pigment dispersion resin.

The pre-treatment liquid includes: 2 mass % or more and 8 mass % or less of a water-soluble cationic polymer; 5 mass % or more and 15 mass % or less of a first moisturizing agent; a first water-soluble organic solvent; a first surfactant; and water.

The first moisturizing agent is trimethylolpropane.

### DETAILED DESCRIPTION OF THE EXEMPLARY EMBODIMENTS

In the above technology, the action of a metal salt that makes pigments more likely to agglomerate tends to reduce the area per dot formed on the recording medium by a single droplet of ink ejected from the recording head. This makes it easier for gaps to occur in the image formed on the recording medium. In this regard, increasing the ejection amount of the water-based ink allows the occurrence of gaps in the image to be suppressed.

However, increasing the ejection amount of the water-based ink tends to cause deeper penetration in the thickness direction of the recording medium, making a phenomenon called “bleed-through” where the image formed on the recording medium becomes visible from the back side more likely to occur. When the bleed-through of water-based ink occurs, during double-sided printing on a recording medium, the image formed on the front side and the image formed on the back side interfere with each other, reducing the visibility of both images.

In view of the circumstances as described above, it is an object of the present disclosure to provide a pre-treatment liquid for a recording medium that is capable of simultaneously suppressing the occurrence of bleed-through of water-based ink and gaps in images.

An embodiment of the present disclosure will be described.

### [Configuration of Ink Set]

An ink set according to an embodiment of the present disclosure includes a pre-treatment liquid and a water-based ink (hereinafter, also referred to simply as an “ink”). A recording medium on which an image is to be formed with the ink set according to this embodiment is a recording medium formed of a fiber such as a cellulose fiber, typically, thin paper. The ink set according to this embodiment tends to provide more advantages when the basis weight of a recording medium on which an image is to be formed is 60 gsm or more and 70 gsm or less.

In the ink set according to this embodiment, the pre-treatment liquid is applied onto the recording surface of the recording medium and then an image is formed with the ink. In the ink set according to this embodiment, by using a pre-treatment liquid that includes a specific component, it is possible to selectively promote the wettability of the ink impacted on the recording medium in the in-plane direction while suppressing the permeability of the ink in the thickness direction, thereby simultaneously suppressing the occurrence of bleed-through of ink and gaps in images.

The above effects of the pre-treatment liquid according to this embodiment are more effectively achieved in combination with the ink in the ink set according to this embodiment. However, the above effects of the pre-treatment liquid according to this embodiment are also effectively achieved in combination with inks other than the ink in the ink set according to this embodiment as long as the inks include a pigment and a pigment dispersion resin. That is, the pre-treatment liquid according to this embodiment is also useful as a standalone product.

### [Pre-Treatment Liquid]

### (Schematic Configuration)

The pre-treatment liquid constituting the ink set according to this embodiment includes a water-soluble cationic polymer, a first moisturizing agent, a first water-soluble organic solvent, a first surfactant, and water. Respective components of the pre-treatment liquid according to this embodiment will be described below.

### (Water-Soluble Cationic Polymer)

In the pre-treatment liquid according to this embodiment, a water-soluble cationic polymer is blended to promote agglomeration of pigments included in the ink. In the pre-treatment liquid according to this embodiment, the action of the water-soluble cationic polymer, which strongly promotes agglomeration of pigments, allows penetration of the ink in the thickness direction on the recording medium to be suppressed. As a result, in the pre-treatment liquid according to this embodiment, it is possible to suppress the occurrence of bleed-through of ink on the recording medium.

Examples of a water-soluble cationic polymer that can be used in the pre-treatment liquid according to this embodiment include an ammonium-containing polymer, an amine-containing polymer, a polyallylamine, a polyvinylamine, a polyimine, a polyvinylpyrrolidone, a polyethyleneimine, a polyvinylpyridine, an aminoacetalized polyvinyl alcohol, an ionene polymer, a polyvinylimidazole, a polyvinylbenzylphosphonium, a polyalkylallylammonium, a polyamidine, and a polyamine sulfone. Among these, examples of the water-soluble cationic polymer that allows more excellent color development to be achieved include a quaternary ammonium-containing polymer (quaternary ammonium salt cationic polymer), a diallyldimethylammonium/sulfur dioxide copolymer, a diallyldimethylammoniumchloride/acrylamide copolymer, a diallyldimethylammoniumchloride polymer, a dimethylamine/ammonia/epichlorohydrin polycondensate. These may be used alone, or two or more of them may be used in combination.

In the pre-treatment liquid according to this embodiment, the content of the water-soluble cationic polymer is 2 mass % or more and 8 mass % or less. In the pre-treatment liquid according to this embodiment, by setting the content of the water-soluble cationic polymer to 2 mass % or more, the effect of suppressing bleed-through of ink on the recording medium can be achieved. In the pre-treatment liquid according to this embodiment, by setting the content of the water-soluble cationic polymer to 8 mass % or less, the effect of hindering ink wet-spreading on a recording medium in the in-plane direction can be kept small.

### (First Moisturizing Agent)

In the pre-treatment liquid according to this embodiment, trimethylolpropane is blended as a first moisturizing agent. In the pre-treatment liquid according to this embodiment, the high moisturizing effect of trimethylolpropane enhances the wettability of ink in the in-plane direction on a recording medium, ensuring the area per dot formed on the recording medium by a single droplet of ink. As a result, in the pre-treatment liquid according to this embodiment, it is possible to suppress the occurrence of gaps in the image formed on the recording medium with the ink.

In the pre-treatment liquid according to this embodiment, the content of trimethylolpropane is 5 mass % or more and 15 mass % or less. In the pre-treatment liquid according to this embodiment, by setting the content of trimethylolpropane to 5 mass % or more, the occurrence of gaps in the image formed on the recording medium with the ink is more likely to be suppressed. In the pre-treatment liquid according to this embodiment, by setting the content of trimethylolpropane to 15 mass % or less, the effect of suppressing bleed-through of ink by the water-soluble cationic polymer is less likely to be impaired.

### (First Water-Soluble Organic Solvent)

In the pre-treatment liquid according to this embodiment, the first water-soluble organic solvent is not limited to a specific type as long as it has compatibility with other components.

Examples of the first water-soluble organic solvent that can be used for the pre-treatment liquid according to this embodiment include glycerin, triethylene glycol, dipropylene glycol monopropyl ether, diethylene glycol, triethylene glycol monomethyl ether, ethylene glycol, propylene glycol monobutyl ether, tripropylene glycol monomethyl ether, diethylene glycol butyl methyl ether, diethylene glycol monomethyl ether, 1,3-propanediol, propylene glycol, propylene glycol monopropyl ether, ethylene glycol monomethyl ether, propylene glycol monoisopropyl ether, diethylene glycol monoethyl ether, ethylene glycol monomethyl ether, monoethyl ether, diethylene glycol monopropyl ether, 2-propanol, dimethyl ether, 1-propanol, diethylene glycol diethyl ether, triethylene glycol monobutyl ether, and 3-methyl-1,5-pentanediol.

In the pre-treatment liquid according to this embodiment, the content of the first water-soluble organic solvent is favorably 10 mass % or more and 50 mass % or less.

### (First Surfactant)

In the pre-treatment liquid according to this embodiment, the first surfactant is not limited to a specific type. In the pre-treatment liquid according to this embodiment, a nonionic surfactant is favorably used as the first surfactant.

Examples of the nonionic surfactant that can be used for the pre-treatment liquid according to this embodiment include a nonionic acrylic resin or its prepolymer. It is favorable that the nonionic acrylic resin is water-soluble and is, for example, a copolymer of a hydrophilic monomer and a hydrophobic monomer. The hydrophilic monomer is favorably, for example, polyethylene glycol acrylate (PEGA), methyl methacrylate (MMA), methyl acrylate (MA), ethyl acrylate (EA), or ethyl methacrylate (EMA). The hydrophobic monomer is favorably, for example, n-butyl acrylate (BA), polypropylene glycol acrylate (PPGA), lauryl acrylate (LA), stearyl acrylate (SA), benzyl acrylate, or benzyl methacrylate.

The nonionic surfactant may be an acetylene glycol surfactant. Examples of the commercially available acetylene glycol surfactant include “OLFINE E1010,” “SURFYNOL 104,” “SURFYNOL 420,” “SURFYNOL 440,” and “KL-870” manufactured by Nissin Chemical Co., Ltd.

In the pre-treatment liquid according to this embodiment, the content of the first surfactant is favorably 0.05 mass % or more and 1 mass % or less.

### (Water)

In the pre-treatment liquid according to this embodiment, ion exchanged water, purified water, distilled water, or the like can be used as water. In the pre-treatment liquid according to this embodiment, the content of water is favorably 40 mass % or more and 80 mass % or less from the viewpoints of dryness and ejection reliability.

### (Other Components)

In the pre-treatment liquid according to this embodiment, a component other than the above may be blended as necessary. For example, in the pre-treatment liquid according to this embodiment, various additives such as a dissolution stabilizer, an anti-drying agent, an antioxidant, a viscosity adjustor, a pH adjuster, and an antifungal agent may be blended as necessary.

### [Water-Based Ink]

### (Schematic Configuration)

The water-based ink constituting the ink set according to this embodiment includes a pigment, a pigment dispersion resin, a second moisturizing agent, a second water-soluble organic solvent, a second surfactant, and water. The ink according to this embodiment is configured such that when used together with the above pre-treatment liquid, the occurrence of bleed-through in a recording medium and gaps in the image formed on the recording medium are more likely to be suppressed simultaneously. Respective components of the ink according to this embodiment will be described below.

### (Pigment)

In the ink according to this embodiment, the pigment may be either an inorganic pigment or an organic pigment. Further, as the pigment, these may be combined with an extender pigment, as necessary.

Specific examples of the inorganic pigment that can be used in the ink according to this embodiment include carbon black and a metal oxide. In particular, in the case of a black ink, carbon black is favorable. Examples of the carbon black include furnace black, thermal lamp black, acetylene black, and channel black.

Specific examples of the organic pigment that can be used in the ink according to this embodiment include an azo pigment, a diazo pigment, a phthalocyanine pigment, a quinacridone pigment, an isoindolinone pigment, a dioxazine pigment, a perylene pigment, a perinone pigment, a thioindigo pigment, an anthraquinone pigment, and a quinophthalone pigment.

In the ink according to this embodiment, the hue is not particularly limited, and a colored pigment of any of colors such as yellow, magenta, cyan, blue, red, orange, and green can be used. Favorable specific examples of the colored pigment include C.I. Pigment Yellow, C.I. Pigment Red, C.I. Pigment Orange, C.I. Pigment Violet, C.I. Pigment Blue, and C.I. Pigment Green. In the ink according to this embodiment, one or more selected from these colored pigments may be used as the pigment.

In the ink according to this embodiment, the content of the pigment is favorably 6 mass % or more and 10 mass % or less.

### (Pigment Dispersion Resin)

In the ink according to this embodiment, a pigment dispersion resin for enhancing the dispersibility of the pigment in the solvent is blended. The pigment dispersion resin is fine particles of a resin and suppresses agglomeration of pigments by being adsorbed on the surface of the pigment. In the ink in which the pigment dispersion resin is blended, the pigment and the pigment dispersion resin integrally form a pigment dispersion. The pigment dispersion includes, for example, a core that includes a pigment and a pigment dispersion resin that coats the core. Part of the pigment dispersion resin may be dispersed in the solvent without being adsorbed on the surface of the pigment.

As the pigment dispersion resin, a known pigment dispersion resin can be appropriately selected and used. Specific examples of the pigment dispersion resin include a styrene-acrylic resin, a styrene-maleic acid copolymer, a styrene-maleic acid half ester copolymer, a vinylnaphthalene-acrylic acid copolymer, and a vinyl naphthalene-maleic acid copolymer. The styrene-acrylic resin is a resin including a unit derived from styrene and a unit derived from acrylic acid, methacrylic acid, acrylic acid ester, or methacrylic acid ester. Examples of the styrene-acrylic resin include a styrene-acrylic acid-acrylic acid alkyl ester copolymer, a styrene-methacrylic acid-methacrylic acid alkyl ester-acrylic acid alkyl ester copolymer, a styrene-acrylic acid copolymer, a styrene-maleic acid-acrylic acid alkyl ester copolymer, a styrene-methacrylic acid copolymer, and a styrene-methacrylic acid alkyl ester copolymer. Of these pigment dispersion resins, a styrene-acrylic resin is favorable, a styrene-methacrylic acid-methacrylic acid alkyl ester-acrylic acid alkyl ester copolymer is more favorable, and a styrene-methacrylic acid-methyl methacrylate-butyl acrylate copolymer is particularly favorable because they are easily prepared and have an excellent effect of dispersing the pigment.

In the ink according to this embodiment, the content of the pigment dispersion resin is favorably 0.5 mass % or more and 8.0 mass % or less. In the ink according to this embodiment, by setting the content of the pigment dispersion resin to 0.5 mass % or more, it is possible to suppress agglomeration of pigments more effectively. In the ink according to this embodiment, by setting the content of the pigment dispersion resin to 8.0 mass % or less, it is possible to suppress the occurrence of ejection failure.

### (Second Moisturizing Agent)

In the ink according to this embodiment, a second moisturizing agent is blended. Examples of the second moisturizing agent that can be used for the ink according to this embodiment include glycerin, sorbitol, urea, and trimethylolpropane.

In the ink according to this embodiment, the content of the second moisturizing agent is favorably 3 mass % or more and 15 mass % or less.

### (Second Water-Soluble Organic Solvent)

In the ink according to this embodiment, the second water-soluble organic solvent is not limited to a specific type as long as it has compatibility with other components. In the ink set according to this embodiment, the second water-soluble organic solvent constituting the ink may be a water-soluble organic solvent common to that of the first water-soluble organic solvent constituting the pre-treatment liquid or a water-soluble organic solvent different from that of the first water-soluble organic solvent constituting the pre-treatment liquid.

Examples of the second water-soluble organic solvent that can be used for the ink according to this embodiment include glycerin, triethylene glycol, dipropylene glycol monopropyl ether, diethylene glycol, triethylene glycol monomethyl ether, ethylene glycol, propylene glycol monobutyl ether, tripropylene glycol monomethyl ether, diethylene glycol butyl methyl ether, diethylene glycol monomethyl ether, 1,3-propanediol, propylene glycol, propylene glycol monopropyl ether, ethylene glycol monomethyl ether, propylene glycol monoisopropyl ether, diethylene glycol monoethyl ether, ethylene glycol monomethyl ether, monoethyl ether, diethylene glycol monopropyl ether, 2-propanol, dimethyl ether, 1-propanol, diethylene glycol diethyl ether, triethylene glycol monobutyl ether, and 3-methyl-1,5-pentanediol. In the ink according to this embodiment, the second water-soluble organic solvent favorably includes at least one of triethylene glycol monobutyl ether or 3-methyl-1,5-pentanediol.

In the ink according to this embodiment, the content of the second water-soluble organic solvent is favorably 10 mass % or more and 50 mass % or less.

### (Second Surfactant)

In the ink according to this embodiment, the second surfactant is not limited to a specific type. In the ink according to this embodiment, a nonionic surfactant is favorably used as the second surfactant. In the ink set according to this embodiment, the second surfactant constituting the ink may be a surfactant common to that of the first surfactant constituting the pre-treatment liquid or a surfactant different from the first surfactant constituting the pre-treatment liquid.

Examples of the nonionic surfactant that can be used for the ink according to this embodiment include a nonionic acrylic resin or its prepolymer. It is favorable that the nonionic acrylic resin is water-soluble and is, for example, a copolymer of a hydrophilic monomer and a hydrophobic monomer. The hydrophilic monomer is favorably, for example, polyethylene glycol acrylate (PEGA), methyl methacrylate (MMA), methyl acrylate (MA), ethyl acrylate (EA), or ethyl methacrylate (EMA). The hydrophobic monomer is favorably, for example, n-butyl acrylate (BA), polypropylene glycol acrylate (PPGA), lauryl acrylate (LA), stearyl acrylate (SA), benzyl acrylate, or benzyl methacrylate.

The nonionic surfactant may be an acetylene glycol surfactant. Examples of the commercially available acetylene glycol surfactant include “OLFINE E1010,” “SURFYNOL 104,” “SURFYNOL 420,” “SURFYNOL 440,” and “KL-870” manufactured by Nissin Chemical Co., Ltd.

In the ink according to this embodiment, the content of the second surfactant is favorably 0.05 mass % or more and 1 mass % or less.

### (Water)

In the ink according to this embodiment, ion exchanged water, purified water, distilled water, or the like can be used as water. In the ink according to this embodiment, the content of water is favorably 40 mass % or more and 80 mass % or less from the viewpoints of dryness and ejection reliability.

### (Other Components)

In the ink according to this embodiment, components other than the above may be blended as necessary. For example, in the ink according to this embodiment, various additives such as a dissolution stabilizer, an antioxidant, a viscosity adjustor, a pH adjuster, and a neutralizer may be blended as necessary.

### EXAMPLES AND COMPARATIVE EXAMPLES

As Examples and Comparative Examples of the present disclosure, preparation of a pre-treatment liquid and an ink, and evaluation of the pre-treatment liquid were performed. Note that the following Examples are merely illustrative examples of the present disclosure, and the present disclosure is not limited to the configurations of the following Examples.

### (Preparation of Pre-Treatment Liquid)

In Examples 1 to 5 and Comparative Examples 1 to 7, pre-treatment liquids having different configurations were prepared. All of the pre-treatment liquids according to Examples 1 to 5 and Comparative Examples 1 to 7 were prepared by stirring predetermined components with a stirrer. In the pre-treatment liquids according to Examples 1 to 5 and Comparative Examples 1 to 7, the types and amounts of components to be blended were varied.

### (Preparation of Ink)

Inks having common configurations were prepared for Examples 1 to 5 and Comparative Examples 1 to 7. First, a pigment dispersion liquid in which a pigment was dispersed in water was prepared. The pigment dispersion liquid was prepared by blending a pigment, a pigment dispersion resin, sodium hydroxide, OLFINE (registered trademark) E1010, and water such that the content shown in Table 1 was achieved.

TABLE 1

| Pigment dispersion liquid | Content (mass %) |
|---|---|
| Pigment | 15 |
| Pigment dispersion resin | 6 |
| NaOH | 0~0.1 |
| OLFINE E1010 | 0.5 |
| Water | Remainder |

As the pigment, carbon black (“Printex (registered trademark) 80” manufactured by Orion Engineered Carbons S.A.) was used. As the pigment dispersion resin, a styrene-acrylic resin having a molecular weight of 20,000 and an acid value of 100 mg KOH/g (monomer composition: MAA/MMA/BA/St) was used. Sodium hydroxide was blended as a neutralizer for neutralizing the pigment dispersion resin. OLFINE (registered trademark) E1010 is a surfactant blended as a dispersant and is a nonionic surfactant manufactured by Nissin Chemical Co., Ltd. As water, ion exchanged water was used.

The pigment dispersion liquid was prepared by mixing the above components by wet dispersion using a media-type wet disperser. Examples of the media-type wet disperser include a wet disperser (more specifically, “Nano Grain Mill” manufactured by ASADA IRON WORKS. CO., LTD., “MSC mill” manufactured by NIPPON COKE & ENGINEERING. CO., LTD., “DYNO (registered trademark)-MILL” manufactured by Shinmaru Enterprises Corporation, and the like).

In the wet dispersion using a media-type wet disperser, media (zirconia beads having a diameter of 0.5 mm) were set in a vessel, and the ejection rate was controlled to be 200 to 600 g/min such that the average particle diameter of the pigment dispersion in which the dispersant had adhered to the pigment dispersed in water was 70 to 130 nm. For measurement of the particle size distributions of the pigment dispersion, a diluted solution obtained by diluting the pigment dispersion liquid 300 times with ion exchanged water was measured using “Zetasizer Nano” manufactured by Sysmex Corporation.

Next, inks according to Examples 1 to 5 and Comparative Examples 1 to 7 were prepared. The inks according to Examples 1 to 5 and Comparative Examples 1 to 7 were prepared such that the contents of the pigment dispersion (solid content), triethylene glycol monobutyl ether (BTG), 3-methyl-1,5-pentanediol (MPD), glycerin, KL-870, and water would be as shown in Table 2. Triethylene glycol monobutyl ether (BTG) and 3-methyl-1,5-pentanediol (MPD) were blended as the second water-soluble organic solvent, and glycerin was blended as the second moisturizing agent. KL-870 is a surfactant and is a nonionic surfactant manufactured by Nissin Chemical Co., Ltd. As water, ion exchanged water was used.

TABLE 2

| Ink | Content (mass %) |
|---|---|
| Pigment dispersion | 8 |
| BTG | 15 |
| MPD | 25 |
| Glycerin | 5 |
| KL870 | 0.4 |
| Water | Remainder |

In the preparation of each ink, the solvent was stirred using a stirrer while the components shown in Table 2 were added thereto in the order. Further, the ink obtained after stirring was filtrated using a filter with a pore size of 5 μm to remove foreign substances, debris, and coarse particles.

### (Evaluation of Pre-Treatment Liquid)

For the pre-treatment liquids according to Examples 1 to 5 and Comparative Examples 1 to 7, the bleed-through density and the line width were evaluated using the above common ink. In the evaluation of bleed-through density, the performance of each pre-treatment liquid in suppressing the bleed-through of ink can be determined. Further, in the evaluation of a line width, the performance of each pre-treatment liquid in suppressing the occurrence of gaps in the image can be determined. The evaluation of bleed-through density and the evaluation of a line width were performed under an environment with a temperature of 32 °C and a relative humidity of 15% RH. In the evaluation of bleed-through density and the evaluation of a line width, an inkjet recording apparatus (an inkjet recording apparatus including a line type recording head, a tester manufactured by KYOCERA Document Solutions Inc.) was used.

### Method of Evaluating Bleed-Through Density

In the evaluation of bleed-through density, first, the pre-treatment liquid was applied onto a recording medium (plain paper “Utrillo” (64 gsm) manufactured by Daio Paper Corporation) and then, the ink was ejected to form a solid image having a rectangular shape of 2.3 cm×11.5 cm. After preserving the plain paper on which the image has been formed in a normal temperature and normal humidity environment for one day and one night, the image densities at five points on the back surface in the solid image on the recording medium were measured using a spectrodensitometer (FD-5, manufactured by Konica Minolta, Inc.), and the average value of the image densities at the five points was used as bleed-through density. The measurement conditions were the observation light source D50, the illumination condition M2, the field of view of 2°, and the density status I. The amount of ink to be ejected from one recording head was adjusted such that the surface density in the solid image on the recording medium would be 1.1 to 1.3. For the bleed-through density, evaluation was performed in accordance with the following criteria A to C. Pre-treatment liquids with the evaluation of A or B for the bleed-through density are evaluated to “Pass,” and pre-treatment liquids with the evaluation of C are evaluated to “Fail.”
A: 0.18 or less
B: more than 0.18 and 0.19 or less
C: more than 0.19

### Method of Evaluating Line Width

In the evaluation of a line width, first, the pre-treatment liquid was applied onto a recording medium (plain paper “Utrillo” (64 gsm) manufactured by Daio Paper Corporation) and then, the ink was ejected to form a 1-dot line (a single line formed by connecting dots). After preserving the plain paper on which the image has been formed in a normal temperature and normal humidity environment for one day and one night, an enlarged image was taken using a microscope (a measurement microscope, manufactured by Nikon Corporation) and the line width of a 1-dot line was measured. The amount of ink to be ejected from one recording head was adjusted such that the density of the 1-dot line on the recording medium would be 1.1 to 1.3. For the line width, evaluation was performed in accordance with the following criteria A to C. Pre-treatment liquids with the evaluation of A or B for the line width are evaluated to “Pass,” and pre-treatment liquids with the evaluation of Care evaluated to “Fail.”
A: 90 μm or more
B: 80 μm or more and less than 90 μm
C: less than 80 μm

### Examples 1 to 5

Pre-treatment liquids according to Examples 1 to 5 were prepared such that the contents of the water-soluble cationic polymer, trimethylolpropane (TMP), 1,3-propanediol (1,3PD), KL-870, and water would be as shown in Table 3. As the water-soluble cationic polymer, a polymer obtained by ion-exchanging at least part of the chloride ion of a diallyldimethylammoniumchloride/sulfur dioxide copolymer (“PAS-A5” manufactured by NITTOBO MEDICAL CO., LTD., a weight average molecular weight Mw of 4000) with a succinic acid anion was used. Trimethylolpropane (TMP) was blended as the first moisturizing agent, 1,3-propanediol (1,3PD) was blended as the first water-soluble organic solvent, and KL-870 was blended as the first surfactant.

TABLE 3

| | | Example | | | | |
|---|---|---|---|---|---|---|
| Pre-treatment liquid | | 1 | 2 | 3 | 4 | 5 |
| Component | Water-soluble | 2 | 8 | 2 | 2 | 8 |
| (mass %) | cationic polymer | | | | | |
| | TMP | 5 | 5 | 10 | 15 | 15 |
| | 1,3PD | 40 | 40 | 40 | 40 | 40 |
| | KL870 | 0.05 | 0.05 | 0.05 | 0.05 | 0.05 |
| | Ion exchanged water | Remainder | Remainder | Remainder | Remainder | Remainder |

Table 4 shows the evaluation results of bleed-through density and a line width for the pre-treatment liquids according to Examples 1 to 5. In all of the pre-treatment liquids according to Examples 1 to 5, both the bleed-through density and the line width were evaluated to “Pass.” Further, comparing Examples 1 and 4 with Examples 2 and 5, a tendency was observed where the higher the content of the water-soluble cationic polymer in the pre-treatment liquid, the lower the bleed-through density.

TABLE 4

| | | Bleed-through density | | Line width | |
|---|---|---|---|---|---|
| | | Evaluation | | Evaluation | |
| | | value | Evaluation | value (μm) | Evaluation |
| Example | 1 | 0.185 | B | 83 | B |
| | 2 | 0.170 | A | 80 | B |
| | 3 | 0.188 | B | 88 | B |
| | 4 | 0.190 | B | 93 | A |
| | 5 | 0.180 | A | 85 | B |

### Comparative Examples 1 to 8

Pre-treatment liquids according to Comparative Examples 1 to 7 were prepared such that the contents of the water-soluble cationic polymer, trimethylolpropane (TMP), 1,3-propanediol (1,3PD), glycerin, urea, KL-870, and water would be as shown in Table 5. As the water-soluble cationic polymer, a polymer obtained by ion-exchanging at least part of the chloride ion of a diallyldimethylammoniumchloride/sulfur dioxide copolymer (“PAS-A5” manufactured by NITTOBO MEDICAL CO., LTD., a weight average molecular weight Mw of 4000) with a succinic acid anion was used. Trimethylolpropane (TMP) was blended as the first moisturizing agent, 1,3-propanediol (1,3PD) was blended as the first water-soluble organic solvent, and KL-870 was blended as the first surfactant.

The pre-treatment liquid according to Comparative Example 1 is different from the pre-treatment liquid according to the above Example in that the content of the water-soluble cationic polymer is less than 2 mass %. The pre-treatment liquid according to Comparative Example 2 is different from the pre-treatment liquid according to the above Example in that the content of the water-soluble cationic polymer exceeds 8 mass %. The pre-treatment liquid according to Comparative Example 3 is different from the pre-treatment liquid according to the above Example in that no first moisturizing agent is included. The pre-treatment liquid according to Comparative Example 4 is different from the pre-treatment liquid according to the above Example in that the content of the first moisturizing agent exceeds 15 mass %. The pre-treatment liquid according to Comparative Example 5 is different from the pre-treatment liquid according to the above Example in that glycerin is used as the first moisturizing agent instead of trimethylolpropane (TMP). The pre-treatment liquid according to Comparative Example 6 is different from the pre-treatment liquid according to the above Example in that urea is used as the first moisturizing agent instead of trimethylolpropane (TMP). The pre-treatment liquid according to Comparative Example 7 is different from the pre-treatment liquid according to the above Example in that the content of the water-soluble cationic polymer is less than 2 mass % and the content of the first moisturizing agent is less than 5 mass %.

TABLE 5

| | | Comparative Example | | | | | | |
|---|---|---|---|---|---|---|---|---|
| Pre-treatment liquid | | 1 | 2 | 3 | 4 | 5 | 6 | 7 |
| Component | Water-soluble | 1 | 10 | 2 | 2 | 2 | 2 | 1 |
| (mass %) | cationic | | | | | | | |
| | polymer | | | | | | | |
| | TMP | 10 | 10 | | 20 | | | 3 |
| | Glycerin | | | | | 15 | | |
| | Urea | | | | | | 15 | |
| | 1,3PD | 40 | 40 | 40 | 40 | 40 | 40 | 40 |
| | KL870 | 0.05 | 0.05 | 0.05 | 0.05 | 0.05 | 0.05 | 0.05 |
| | Ion exchanged | Remain- | Remain- | Remain- | Remain- | Remain- | Remain- | Remain- |
| | water | der | der | der | der | der | der | der |

In Comparative Example 8, an ink in which a self-dispersing pigment is blended as a pigment and no pigment dispersion resin is blended unlike the inks according to Examples 1 to 5 and Comparative Examples 1 to 7 was prepared. The ink according to Comparative Example 8 has configurations common to those of the inks according to Examples 1 to 5 and Comparative Examples 1 to 7 other than the pigment and the pigment dispersion resin. In Comparative Example 8, the bleed-through density and the line width were evaluated using the pre-treatment liquid according to Example 4 and the ink according to Comparative Example 8.

Table 6 shows the evaluation results of bleed-through density and a line width for the pre-treatment liquids according to Comparative Examples 1 to 8. In Comparative Example 1 in which the content of the water-soluble cationic polymer in the pre-treatment liquid was low, the pigment did not sufficiently agglomerate and the bleed-through density was evaluated to “Fail.” In Comparative Example 2 in which the content of the water-soluble cationic polymer in the pre-treatment liquid was high, the pigment excessively agglomerated and the line width was evaluated to “Fail.” In Comparative Example 3 in which the pre-treatment liquid did not include trimethylolpropane (TMP), the ink did not wet-spread in the in-plane direction sufficiently and the line width was evaluated to “Fail.” In Comparative Example 4 in which the content of trimethylolpropane (TMP) in the pre-treatment liquid was high, the ink penetrated not only in the in-plane direction but also the thickness direction and the bleed-through density was evaluated to “Fail.” In Comparative Examples 5 and 6 in which glycerin or urea having shorter carbon chain than trimethylolpropane (TMP) was used as the first moisturizing agent, the moisturizing effect of the first moisturizing agent was insufficient, the pre-treatment liquid and the ink did not blend well, and the line width was evaluated to “Fail.” In Comparative Example 7 in which the content of the water-soluble cationic polymer and the content of trimethylolpropane (TMP) in the pre-treatment liquid were low, both the bleed-through density and the line width were evaluated to “Fail.” In Comparative Example 8 in which the ink included no pigment dispersion resin, agglomeration of pigments could not be suppressed by sufficiently by trimethylolpropane (TMP) and the line width was evaluated to “Fail.”

TABLE 6

| | | Bleed-through density | | Line width | |
|---|---|---|---|---|---|
| | | Evaluation | | Evaluation | |
| | | value | Evaluation | value (μm) | Evaluation |
| Comparative | 1 | 0.230 | C | 90 | A |
| Example | 2 | 0.160 | A | 75 | C |
| | 3 | 0.181 | B | 73 | C |
| | 4 | 0.195 | C | 95 | A |
| | 5 | 0.188 | B | 78 | C |
| | 6 | 0.190 | B | 77 | C |
| | 7 | 0.210 | C | 76 | C |
| | 8 | 0.165 | A | 70 | C |

It should be understood by those skilled in the art that various modifications, combinations, sub-combinations and alterations may occur depending on design requirements and other factors insofar as they are within the scope of the appended claims or the equivalents thereof.

What is claimed is:

1. A pre-treatment liquid for a recording medium on which an image is recorded with a water-based ink that includes a pigment and a pigment dispersion resin, comprising:
2 mass % or more and 8 mass % or less of a water-soluble cationic polymer;
5 mass % or more and 15 mass % or less of a first moisturizing agent;
a first water-soluble organic solvent;
a first surfactant; and
water,
the first moisturizing agent being trimethylolpropane.

2. The pre-treatment liquid according to claim 1, wherein
the recording medium is formed of a fiber to have a basis weight of 60 gsm or more and 70 gsm or less.

3. The pre-treatment liquid according to claim 1, wherein
the water-based inks further includes a second moisturizing agent, a second water-soluble organic solvent, a second surfactant, and water, and
the second water-soluble organic solvent includes at least one of triethylene glycol monobutyl ether or 3-methyl-1,5-pentanediol.

4. An ink set, comprising:
the pre-treatment liquid according to claim 1; and
a water-based ink that includes a pigment, a pigment dispersion resin, a second water-soluble organic solvent, a second surfactant, and water, the second water-soluble organic solvent including at least one of triethylene glycol monobutyl ether or 3-methyl-1,5-pentanediol.
